(19) United States
(12) Patent Application Publication
(10) Pub. No.: US 2007/0209412 A1
(43) Pub. Date: Sep. 13, 2007

(54) Cylinder lock device and engagement release mechanism

(75) Inventors: Toshiharu Shiramizu, Aichi (JP); Yoshiyuki Seki, Aichi (JP)

Correspondence Address: SCULLY SCOTT MURPHY & PRESSER, PC, 400 GARDEN CITY PLAZA, SUITE 300, GARDEN CITY, NY, 11530, US

(73) Assignee: Tokai Rika Co., Ltd., Aichi (JP)

(21) Appl. No.: 11/713,979

(22) Filed: Mar. 5, 2007

(30) Foreign Application Priority Data
Mar. 7, 2006 (JP) 2006-060605

(51) Int. Cl. E05B 47/00

(52) U.S. Cl. 70/276

(57) ABSTRACT

A cylinder lock device (1) includes: a rotor (30) rotatably disposed inside a cylindrical case body (20), a key insertion hole (31) being formed in the rotor (30) to axially extend; tumblers (50) provided in the rotor (30) to be axially movable, the tumblers (50) being radially urged outward to be engaged with a sleeve (40), the engagement of the tumblers (50) with the sleeve (40) being released when a normal key is inserted into a key insertion hole (31); slide members (70) for axially moving toward a lever member (60) side whenever the sleeve (40) relatively rotates by a predetermined angle with respect to the case body (20); a clutch member (80) disposed between the rotor (30) and the lever member (60), the clutch member (80) being provided in the lever member (60) to be axially movable; and an urgement member (90) for urging the clutch member (80) to a rotor (30) side so that the clutch member (80) is engaged with the rotor (30), in which when the slide members (70) move toward the lever member (60) side, the engagement of the clutch member (80) with the rotor (30) is released.

### BACKGROUND OF THE INVENTION

1. Field of the Invention

The invention relates to a cylinder lock device which is constructed such that when an improper key or a foreign object such as a driver is inserted into a key insertion hole, only a rotor and a sleeve are rotated with respect to a case body, and an engagement release mechanism.

2. Description of the Related Art

A cylinder lock device including a rotor which is rotatably disposed inside a cylindrical case body and which has a key insertion hole formed so as to axially extend is known as one for use in a door or the like of an automobile vehicle. In the cylinder lock device, a plurality of tumblers are provided in the rotor so as to be radially movable and each of the tumblers is radially urged outward to be engaged with a sleeve. Also, when a key is inserted into the key insertion hole, each of the tumblers is moved by an urging force provided by grooves of the key. When a normal key is inserted into the key insertion hole, the engagement of each of the tumblers with the sleeve is released, so that the rotor and the sleeve can rotate independently of each other. Also, the rotation of the key causes the lever member to rotate together with the rotor, thereby performing release or lock of the cylinder lock device.

A key both sides of which have the same shape has been conventionally used in this sort of cylinder lock device in many cases. Thus, the cylinder lock device in which the rotor is positioned at intervals of 180° with respect to the case body is the mainstream of this sort of cylinder lock device. However, from a problem about concealment or the like, a cylinder lock device is proposed in which a rotor is positioned at intervals of 360° with respect to a case body in order to cope with a key both sides of which have different shapes, respectively. This type of cylinder lock device, for example, is disposed in Japanese Patent Laid-open No. 8-4378.

Moreover, in recent years, a freewheel mechanism is proposed in which when an improper key or a foreign object such as a driver is inserted into a key insertion hole, only a rotor and a sleeve are rotated with respect to a case body. The cylinder lock device disclosed in Japanese Patent Laid-open No. 8-4378 also adopts the freewheel mechanism. In the cylinder lock device, a movement portion which is radially movable is provided in the case body. In this case, the movement portion is radially urged inward to be engaged with a recess portion formed in a peripheral surface of a sleeve. Also, when the rotor is rotated by using any of improper keys other than a normal key, the movement portion engaged with the sleeve radially moves outward, so that the sleeve becomes rotatable with respect to the case body.

However, in the cylinder lock device disclosed in Japanese Patent Laid-open No. 8-4378, in order to ensure a stroke of the movement portion, an installation portion for the movement portion in the case body is compelled to radially protrude outward. As a result, there is encountered such a problem that the cylinder lock device is radially scaled up.

### SUMMARY OF THE INVENTION

The present invention has been made in the light of the circumstances described above, and it is therefore an object of the invention to provide a cylinder lock device and an engagement release mechanism each of which is capable of being radially miniaturized.

In order to attain the above-mentioned object, according to the present invention, there is provided a cylinder lock device, including;

a cylindrical case body;

a rotor rotatably disposed inside the cylindrical case body, a key insertion hole being formed in the rotor so as to axially extend;

a sleeve rotatably disposed between the cylindrical case body and the rotor;

a plurality of tumblers provided in the rotor so as to be radially movable, the plurality of tumblers being radially urged outward to be engaged with the sleeve, the engagement of the plurality of tumblers with the sleeve being released when a normal key is inserted into the key insertion hole;

a rotatable lever member disposed on a side opposite to a key insertion side in the rotor so as to face the key insertion side;

a slide member disposed between the sleeve and the cylindrical case body, the slide member axially moving toward the lever member side whenever the sleeve relatively rotates with respect to the cylindrical case body by a predetermined angle;

a clutch member disposed between the rotor and the lever member, the clutch member being movably provided axially in the lever member; and

an urgement member for urging the clutch member to the rotor side so that the clutch member is engaged with the rotor;

in which when the slide member moves toward the lever member side, the engagement of the clutch member with the rotor is released.

According to the cylinder lock device, when a normal key is inserted into the key insertion hole, the engagement of the plurality of tumblers with the sleeve is released, so that the rotor and the sleeve can rotate independently of each other. When the key is rotated in this state, the clutch member engaged with the rotor rotates together with the lever member, which makes it possible to perform the release or the lock of the cylinder lock device.

On the other hand, when an improper key or a foreign object such as a driver is inserted into the key insertion hole, no engagement of the plurality of tumblers with the sleeve is released, so that the rotor and the sleeve can rotate together with each other. When the key is rotated in this state, the sleeve relatively rotates together with the rotor with respect to the case body. Also, whenever the sleeve rotates together with the rotor with respect to the case body by a predetermined angle, the slide member moves to the lever member side, thereby releasing the engagement of the clutch member with the rotor. As a result, even when the key is rotated, the rotor and the sleeve merely rotate. Hence, no load is applied to any of other components or parts, and thus an inside of the cylinder lock device is prevented from being damaged by a mischief or the like.

As described above, the axial movement of the slide member prevents the case body from radially protruding as in the conventional cylinder lock device. As a result, the radial size of the case body can be remarkably reduced.

In addition, in the cylinder lock device, preferably, the cylinder lock device further comprises a cam mechanism having a slidable contact surface formed in the case body, and a slidable contact portion formed in the slide portion, the slidable contact portion being adapted to be slidably in contact with the slidable contact surface, the cam mechanism serving to move axially the slide portion when the sleeve relatively rotates with respect to the case body.

In addition, in the cylinder lock device, preferably, the predetermined angle is set as 360°.

In addition, in the cylinder lock device, preferably, the predetermined angle is set as 180°.

In addition, in the cylinder lock device, preferably, in a state in which the engagement of the clutch member with the rotor is released, the clutch member urged by the urgement member is slidably in contact with the rotor.

In addition, in the cylinder lock device, preferably, a protrusion portion is formed in the rotor, and a recess portion which is engageable with the protrusion portion is formed in the clutch member, and in a state in which the engagement of the clutch member with the rotor is released, a portion other than the recess portion in the clutch portion is slidably in contact with the protrusion portion.

In addition, in the cylinder lock device, preferably, a protrusion portion which is engageable with the recess portion of the clutch member is formed in a peripheral surface on a side opposite to the key insertion side in the rotor.

In addition, in the cylinder lock device, preferably, the two protrusion portions are formed in the rotor at an interval of about 180°, and shapes of the recess portions of the clutch member are formed in correspondence to the two protrusion portions of the rotor.

Also, in the cylinder lock device, preferably, the two protrusion portions of the rotor are formed in shapes different from each other, and the recess portions of the clutch member are also formed in shapes different from each other in correspondence to the two protrusion portions of the rotor having the different shapes.

Also, in the cylinder lock device, preferably, in a state in which the engagement of the clutch member with the rotor is released, the clutch member urged by the urgement member is slidably in contact with the slide member.

Also, in the cylinder lock device, preferably, the slide member is formed in nearly T-like shape, and has an axial extension portion which extends axially, and a circumferential extension portion which circumferentially extends at an end portion on the clutch member side of the axial extension portion and which is wider than the axial extension portion, and the circumferential extension portion is slidably in contact with the clutch member.

Also, in the cylinder lock device, preferably, a reception groove which movably receives axially the slide member is formed in a side face of the sleeve.

Also, in the cylinder lock device, preferably, the two slide members are provided and are disposed in two reception grooves which are formed on a peripheral surface of the sleeve, respectively, so as to be axially movable.

Also, in the cylinder lock device, preferably, a cylinder portion which extends toward the lever member is formed in the clutch member, a plurality of coupling portions are protrusively formed in a head of the cylinder portion, and the plurality of coupling portions are inserted through insertion windows formed in the lever member, respectively.

In the cylinder lock device, preferably, the lever member is rotatably constructed, and the lever member rotates, thereby performing release or lock of the cylinder lock device used in a door of an automobile.

In addition, in order to attain the above-mentioned object, according to the invention, there is provided an engagement release mechanism for use in a cylinder lock device in which when a normal key is rotated in a state in which the normal key is inserted into a rotor disposed inside a cylindrical case body, a lever member rotates together with the rotor, thereby performing release or lock of the cylinder lock device, the engagement release mechanism serving to release engagement of the lever member with the rotor when an improper key is rotated in a state in which the improper key is inserted into the rotor, thereby idling the rotor with respect to the lever member, the engagement release mechanism including:

a clutch member for being engaged or de-engaged with or from the rotor or the lever member due to its axial movement;

a slidable contact surface formed in an inner surface of a cylindrical case body so as to circumferentially extend; and

a slide member for being slidably in contact with the slidable contact surface, the slide member axially moving along the slidable contact surface when an improper key is rotated in a state in which the improper key is inserted into the rotor to abut against the clutch member, thereby releasing the clutch member from the rotor or the lever member.

In addition, in the engagement release mechanism, preferably, in a state in which the engagement of the clutch member with the rotor is released, the clutch member is slidably in contact with the rotor.

In addition, in the engagement release mechanism, preferably, a protrusion portion is formed in the rotor, and a recess portion which is engageable with the protrusion portion is formed in the clutch member, and in a state in which the engagement of the clutch member with the rotor is released, a portion other than the recess portion in the clutch portion is slidably in contact with the protrusion portion.

In addition, in the engagement release mechanism, preferably, the two protrusion portions are formed in the rotor at an interval of about 180°, and shapes of the recess portions of the clutch member are formed in correspondence to the two protrusion portions of the rotor.

Also, in the engagement release mechanism, preferably, the two protrusion portions of the rotor are formed in shapes different from each other, and the recess portions of the clutch member are also formed in shapes different from each other in correspondence to the two protrusion portions of the rotor having the different shapes.

Also, in the engagement release mechanism, preferably, in a state in which the engagement of the clutch member with the rotor is released, the clutch member is slidably in contact with the slide member.

In the engagement release mechanism, preferably, the slide member is formed in nearly T-like shape, and has an axial extension portion which extends axially, and a circumferential extension portion which circumferentially extends at an end portion on the clutch member side of the axial extension portion and which is wider than the axial extension portion, and the circumferential extension portion is slidably in contact with the clutch member.

As described above, according to the invention, the radial miniaturization can be realized. As a result, for example, a degree of freedom of a design on a vehicle side in a phase of installation of the cylinder lock device and the engagement release mechanism in the vehicle is increased.

### BRIEF DESCRIPTION OF THE DRAWINGS

FIG. 1 is an exploded perspective view of a cylinder lock device according to an embodiment of the invention;

FIG. 2 is a vertical cross sectional view of the cylinder lock device in an initial state according to the embodiment of the invention;

FIG. 3 is a cross sectional view, showing a relationship between a rotor and a clutch member, taken on line A - A of FIG. 2;

FIG. 4 is a perspective view showing an external appearance of the clutch member;

FIG. 5 is a vertical cross sectional view of the cylinder lock device shown in FIG. 1 in a state in which the rotor is rotated by 180° by using an improper key;

FIG. 6 is a cross sectional view, showing a relationship between the rotor and the clutch member, taken on line B-B of FIG. 5;

FIG. 7 is a vertical cross sectional view of the cylinder lock device shown in FIG. 1 in a state in which a slide bar moves to a key insertion side when the rotor is rotated by 180° by using the improper key;

FIG. 8 is a vertical cross sectional view of a cylinder lock device of a change of the embodiment shown in FIG. 1 in an initial state;

FIG. 9 is a cross sectional view, showing a relationship among a case body, a rotor and a slider bar, taken on line C-C of FIG. 8;

FIG. 10 is a cross sectional view, showing a relationship among the case body, the rotor and the slider bars, taken on line D-D of FIG. 8; and

FIG. 11 is a vertical cross sectional view of the cylinder lock device of the change in a state in which the rotor is rotated by 180° by using an improper key.

### DETAILED DESCRIPTION OF PREFERRED EMBODIMENTS

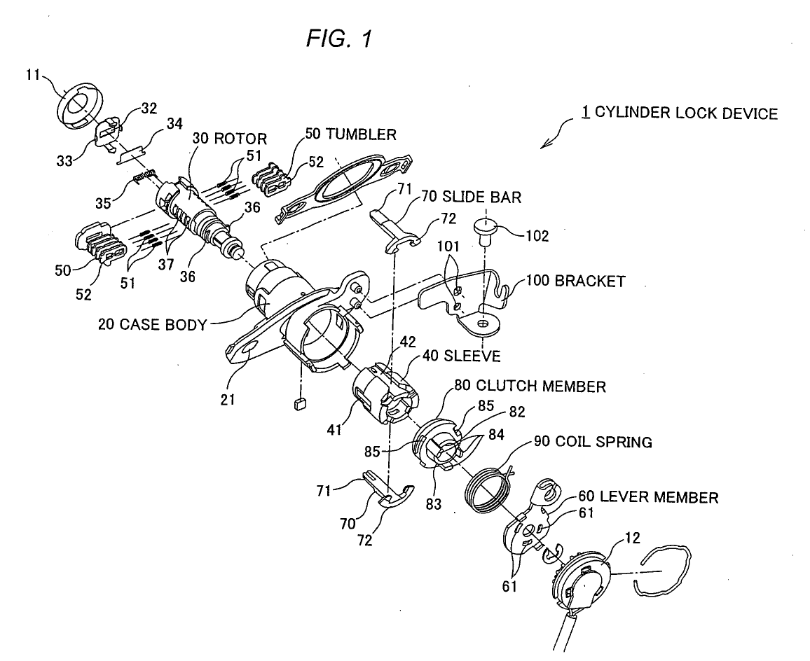

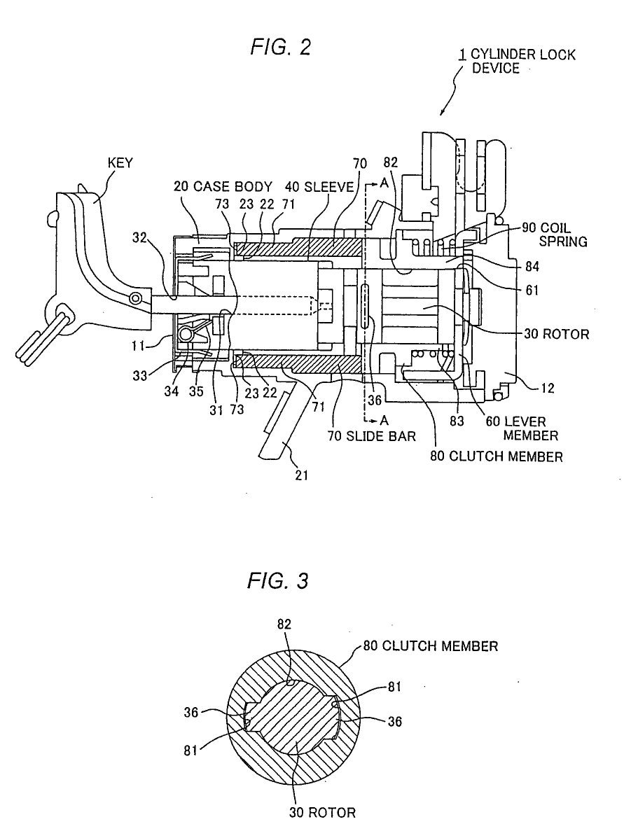

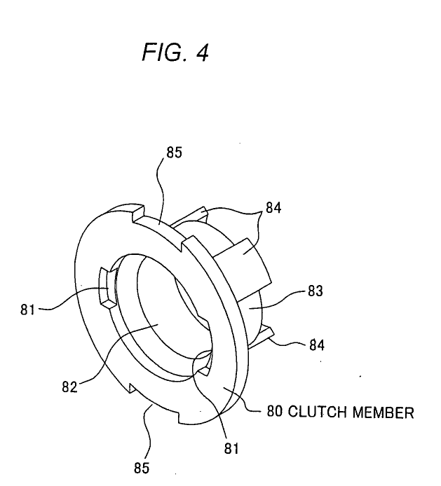

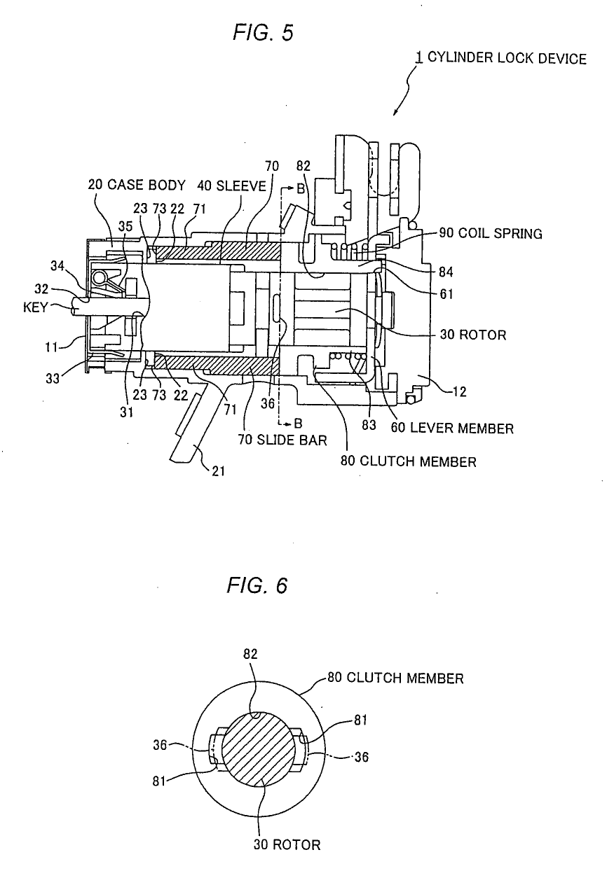

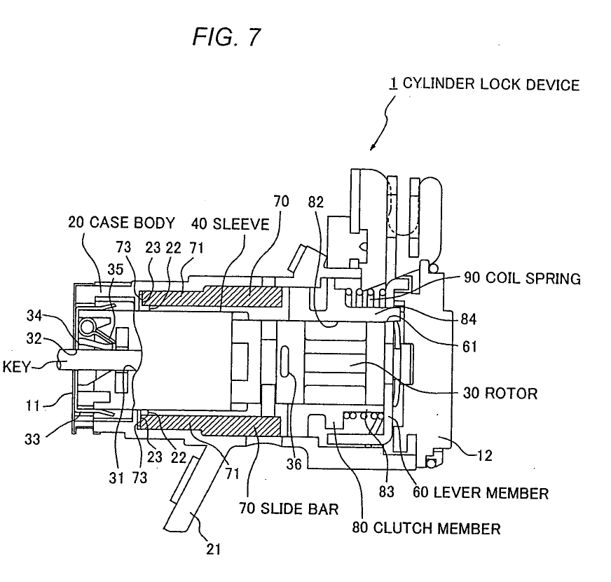

A cylinder lock device according to an embodiment of the invention will be described in detail hereinafter with reference to FIGS. 1 to 7. FIG. 1 is an exploded perspective view of a cylinder lock device according to an embodiment of the invention, FIG. 2 is a vertical cross sectional view of the cylinder lock device in an initial state according to the embodiment of the invention, FIG. 3 is a cross sectional view, showing a relationship between a rotor and a clutch member, taken on line A-A of FIG. 2, FIG. 4 is a perspective view showing an external appearance of the clutch member, FIG. 5 is a vertical cross sectional view of the cylinder lock device shown in FIG. 1 in a state in which the rotor is rotated by 180° by using an improper key, FIG. 6 is a cross sectional view, showing a relationship between the rotor and the clutch member, taken on line B-B of FIG. 5, and FIG. 7 is a vertical cross sectional view of the cylinder lock device shown in FIG. 1 in a state in which a slide bar moves to a key insertion side when the rotor is rotated by 180° by using the improper key. Note that, in each of the cross sectional views of FIGS. 2, 3, 5, 6 and 7, illustration is made with hatching being suitably omitted for the sake of convenience of a description.

As shown in FIG. 1, the cylinder lock device 1 includes a nearly cylindrical case body 20, a rotor 30 which is rotatably disposed inside the nearly cylindrical case body 20, a sleeve 40 which is rotatably disposed between the case body 20 and the rotor 30, a plurality of tumblers 50 which are provided in the rotor 30 so as to be radially movable, and a rotatable lever member 60 which is disposed on a side opposite to a key insertion side in the rotor 30 so as to face the key insertion side. An end portion of the case body 20 on a key insertion side is covered with a case cover 11, and an end portion of the case body 20 on a side opposite to the key insertion side is covered with a switch unit 12. In the cylinder lock device 1, when a normal key is rotated in a state in which the normal key is inserted into the rotor 30, the lever member 60 rotates together with the rotor 30. Here, the cylinder lock device 1 includes an engagement release mechanism for, when the rotor 30 is forcibly rotated by using an improper key or a foreign object such as a driver, releasing the engagement of a lever member 60 side with a rotor 30 side, thereby idling the rotor 30 with respect to the lever member 60. Thus, the cylinder lock device 1 adopts a so-called freewheel system.

More specifically, the cylinder lock device 1, as shown in FIG. 1, includes slide bars 70, each serving as a slider member, which are disposed between the sleeve 40 and the case body 20, a clutch member 80 which is disposed between the rotor 30 and the lever member 60, and a coil spring 90 which urges the clutch member 80 to the rotor 30 side so that the clutch member 80 contacts the rotor 30. A freewheel mechanism is realized in cooperation with the slide bars 70, the clutch member 80 and the coil spring 90. The cylinder lock device 1 will be described in detail hereinafter.

As shown in FIG. 1, a protrusion plate portion 21 having a plate surface which is directed axially is formed in a peripheral surface of the case body 20. Protrusions adapted to be inserted through insertion windows 101, respectively, which are formed in a fixing bracket 100 are formed in the protrusion plate portion 21. The bracket 100 is fixed to an automobile body by using a bolt 102, so that the case body 30 is fixed to the automobile body through the bracket 100.

The rotor 30 shows a nearly cylindrical shape, and as shown in FIG. 2, a key insertion hole 31 is formed in the rotor 30 so as to axially extend. As shown in FIG. 1, a key insertion side of the rotor 30 is covered with a rotor cover 33 having a key insertion window 32 formed at its center. A shutter member 34 which covers the key insertion window 32 in a state in which no key is inserted through the key insertion window 32 is provided on a back face side of the rotor cover 33. The shutter member 34 is urged in a direction of closing the key insertion window 32 by a spring 35 for the shutter member 34.

In addition, as shown in FIG. 1, protrusion portions 36 which can be engaged with recess portions 81 (refer to FIG. 4) of the clutch member 80, respectively, are formed in a peripheral surface on a side opposite to the key insertion side in the rotor 30. The protrusion portions 36 extend circumferentially and are formed at an interval of about 180° by two. As shown in FIG. 3, in this embodiment, the two protrusion portions 36 are different in shape from each other, and the two recess portions 81 are also different in shape from each other in correspondence to the different shapes of the two protrusion portions 36. For this reason, the number of relative angles at which the two protrusion portions 36 can be engaged with the two recess portions 81, respectively, is set as one. Moreover, as shown in FIG. 1, grooves 37 through which tumblers 50 are radially guided, respectively, are formed in the rotor 30. In this embodiment, the eight tumblers 50 in total are disposed alternately, and thus the eight grooves 37 in total are formed in the rotor 30.

The eight tumblers 50 are radially urged outward by eight springs 51 for the tumblers 50 which are accommodated in the eight grooves 37, respectively. Engagement grooves 41 which are engaged with radial outside end portions of the eight tumblers 50 are formed in the sleeve 40. Thus, the engagement grooves 41 are engaged with the eight tumblers 50 which are radially urged outward, which results in that the rotor 30 and the sleeve 40 rotate together with each other. Holes 52 corresponding to a normal key are formed in each of the eight tumblers 50. Thus, the eight tumblers 50 radially move in correspondence to groove shapes of the normal key inserted into the key insertion hole 31 of the rotor 30. When the normal key is inserted into the key insertion hole 31 of the rotor 30, the engagement of the eight tumblers 50 with the sleeve 40 is released because all the eight tumblers 50 are released from the sleeve 40, so that the rotor 30 and the sleeve 40 can move independently of each other.

As shown in FIG. 1, the sleeve 40 shows a nearly cylindrical shape, and the pair of engagement grooves 41 which axially extend is formed in a side face of the sleeve 40. In addition, reception grooves 42 which movably receive axially the above-mentioned two slide bars 70, respectively, are formed in the side face of the sleeve 40. In this embodiment, the slide bars 70 are provided by two, and the engagement grooves 41 and the reception grooves 42 are alternately disposed at intervals of about 90°.

As shown in FIG. 1, each of the two slide bars 70 is formed in nearly T-like shape, and has an axial extension portion 71 which is received by the corresponding one of the reception grooves 42 of the sleeve 40 and which extends axially, and a circumferential extension portion 72 which circumferentially extends at an end portion, on the clutch member 80 side, of the axial extension portion 71. Each of the two slide bars 70 axially moves toward the lever member 60 side whenever the sleeve 40 relatively rotates with respect to the case body 20 by a predetermined angle. In this embodiment, the predetermined angle is set as 360°.

As shown in FIG. 2, an inner surface of the case body 20 is formed in step-like shape so that its inside diameter changes in the individual steps. An end face 73 on a side opposite to the circumferential extension portion 72 in the axial extension portion 71 is slidably in contact with a step-like slidable contact surface 22 of the case body 20. Recess portions 23 are formed in predetermined positions of the slidable contact surface 22 which circumferentially extends. Here, an end face 73 of each of the slide bars 70, and circumferential both ends of each of the recess portions 23 are inclined. Thus, when the slide bars 70 and the recess portions 23 relatively move circumferentially, the slide bars 70 are smoothly inserted or de-inserted into or from the recess portions 23, respectively. That is to say, the cylinder lock device 1 includes a cam mechanism having the slidable contact surface 22 formed in the case body 20, and the end face 73 as a slidable contact portion which is formed in each of the slide bars 70 and which is slidably in contact with the slidable contact surface 22. Thus, in the cam mechanism, the relative rotation of the sleeve 40 made with respect to the case body 20 results in each of the slide bars 70 being axially moved.

Each of the circumferential extension portions 72 abuts against the clutch member 86 urged by a coil spring 90, so that the slide bars 70 are urged together with the clutch member 80 to the key insertion side. The slide bars 70 are engaged with the respective recess portions 23 of the case body 20 in an initial state by this urging force. When the sleeve 40 relatively rotates from the initial state with respect to the case body 20, the slide bars 70 are de-engaged from the respective recess portions 23 against the urging force to axially move to the lever member 60 side. In the manner described above, each of the slide bars 70 axially moves along the slidable contact surface 22, thereby releasing the clutch member 80 from the lever member 60. That is to say, the above-mentioned engagement release mechanism includes the clutch member 80, the slidable contact surface 22 formed in the case body 20, and the slide bars 70. Here, as shown in FIG. 1, the end portion on the clutch member 80 side of the sleeve 40 is partially cut away in correspondence to the circumferential extension portions 72 of the slide bars 70.

As shown in FIG. 1, the clutch member 80 shows a nearly disc-like shape, and a reception hole 82 which receives the head side of the rotor 30 is formed at a center of the clutch member 80. A cylinder portion 83 which extends toward the lever member 60 is formed in the clutch member 80. A plurality of coupling portions 84 are protrusively formed in a head of the cylinder portion 83. The plurality of coupling portions 84 are inserted through insertion windows 61 formed in the lever member 60, respectively. Thus, the clutch member 80 is provided in the lever member 60 so as to be axially movable.

Each of the above-mentioned recess portions 81 is formed in an inner periphery of the reception hole 82 of a surface on the key insertion side in the clutch member 80 (refer to FIG. 3). As a result, in the case of an angle at which none of the protrusion portions 36 are engaged with the respective recess portions 81, each of the protrusion portions 36 interferes with the surface on the key insertion side in the clutch member 80, thereby allowing the rotor 30 to relatively rotate with respect to the clutch member 80. That is to say, in a state in which the engagement of the clutch member 80 with the rotor 30 is released, any of portions other than the recess portions 81 in the clutch member 80 is slidably in contact with the protrusion portions 36. In the manner described above, in the state in which the engagement of the clutch member 80 with the rotor 30 is released, the urging force applied from the coil spring 90 to the clutch member 80 is received by the rotor 30.

In addition, a plurality of notches 85 with which the clutch member 80 is positioned for the case body 20 are formed in a plurality of portions of the periphery of the clutch member 80. Here, in this embodiment, the clutch member 80 is engaged or de-engaged with or from the rotor 30 due to its axial movement. However, the clutch member 80 may also be engaged or de-engaged with or from the lever member 60.

The coil spring 90 is formed by turning a coil around the cylinder portion 83 and the coupling portions 84 of the clutch member 80. Also, the coil spring 90 is held between the surface on the lever member 60 side of the clutch 80 and the surface on the rotor 30 side of the lever member 60. The lever member 60 is rotatably constructed. Thus, the rotation of the lever member 60 results in that the release or the lock of the cylinder lock device 1 used in the door of the automobile being performed. The release or the lock of the cylinder lock device 1 used in the door of the automobile, for example, may be directly performed by connecting a wire for door lock to the lever member 60, or may be indirectly by providing a switch for detecting a rotating angle of the lever member 60.

In the cylinder lock device 1 constructed in the manner as described above, since the rotor 30 and the clutch member 80 are engaged with each other only at one relative angle, the rotor 30 and the clutch member 80 are engaged with each other whenever the rotor 30 relatively rotates by 360° with respect to the clutch member 80. Thus, the inserted key cannot be de-inserted from the key insertion hole 31 of the rotor 30 unless the rotor 30 relatively rotates by 360° with respect to the clutch member 80. That is to say, in a state in which the rotor 30 rotates from the initial state, as shown in FIG. 5, the clutch member 80 moves to the lever member 60 side, so that the rotor 30 and the clutch member 80 are slidably in contact with each other. FIG. 5 shows a state in which the rotor 30 rotates by 180° from the initial state. In this state, as shown in FIG. 6, none of the protrusion portions 36 are engaged with the respective recess portions 81. Note that, in the state of the rotation of 180°, each of the slide bars 70 is in a free state. Thus, when an acceleration or the like is applied to the cylinder lock device 1, or the cylinder lock device 1 is installed so that the key insertion side becomes the lower side, as shown in FIG. 7, the slide bars 70 axially move to be engaged with the recess portions 23, respectively. As described above, unlike the conventional cylinder lock device with which the key can be de-inserted from the key insertion hole of the rotor whenever the rotor relatively rotates by 180° with respect to the clutch member, when a key two sides of which have different shapes is used, the key cannot be inserted into the key insertion hole with its both sides being reversed.

In addition, according to the cylinder lock device 1 of this embodiment, when the normal key is inserted into the key insertion hole 31 of the rotor 30, the engagement of the tumblers 50 with the sleeve 40 is released, so that the rotor 30 and the sleeve 40 can rotate independently of each other. When the normal key is rotated in this state, the clutch member 80 engaged with the rotor 30 rotates together with the lever member 60, which makes it possible to perform the release or the lock of the cylinder lock device 1.

In addition, when an improper key or a foreign object such as a driver is inserted into the key insertion hole 31 of the rotor 30, no engagement of the tumblers 50 with the sleeve 40 is released, so that the rotor 30 and the sleeve 40 rotate together with each other. When the improper key is rotated in this state, the sleeve 40 relatively rotates together with the rotor 30 from the initial position with respect to the case body 20, and the slide bars 70 move to the lever member 60 side, thereby releasing the engagement of the rotor 30 with the clutch member 80. As a result, even when the improper key is rotated, the rotor 30 and the sleeve 40 merely rotate together with each other. Thus, no load is applied to any of other components or parts, or the like, which results in that the inside of the cylinder lock device 1 is prevented from being damaged by a mischief or the like.

As described above, the axial movement of the slide bars 70 prevents the case body 20 from radially protruding as in the conventional cylinder lock device. As a result, the radial size of the case body 20 can be remarkably reduced. Consequently, the realization of the radial miniaturization increases the degree of freedom of the design on the vehicle side in the phase of installation of the cylinder lock device 1 in the vehicle.

In addition, according to the cylinder lock device 1 of this embodiment, the clutch member 80 is moved by the pair of slide bars 70 which are disposed symmetrically with respect to the axial direction. As a result, the biased load is prevented from being applied to the clutch member 80. Thus, the cylinder lock device 1 has the relatively high durability in terms of the reliability. In addition, the common use of the slide bars 70 allows the manufacturing cost to be reduced.

Moreover, since ach of the protrusion portions 36 of the rotor 30 interferes with the clutch member 80 when the clutch member 80 moves to the lever member 60 side, no urging force is applied from the coil spring 90 to each of the slide bars 70 during the interference. As described above, each of the slide bars 70 becomes the free state, which results in that it is possible to reduce a frictional force generated by the slide bars 70, and thus it is possible to lighten an operation force required to rotate the rotor 30. Consequently, the cylinder lock device 1 is very advantageous for an practical application.

It should be noted that although in the embodiment described above, the cylinder lock device 1 has been exemplified as one with which the release and the lock for the door of the automobile vehicle are performed, the invention, for example, can also be applied to a cylinder lock device with which the release and the lock for a door of a house, a drawer or the like are performed.

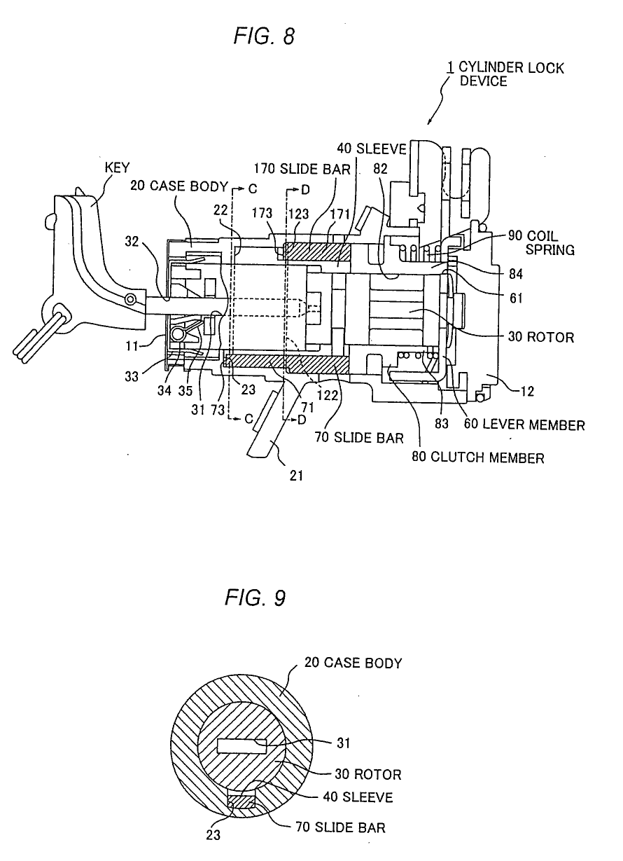

In addition, the embodiment described above has shown the cylinder lock device 1 in which in the state in which the engagement of the clutch member 80 with the rotor 30 is released, the urging force applied from the coil spring 90 to the clutch member 80 is received by the rotor 30. However, for example, as shown in FIG. 8, that urging force may be received by slide bars 70 and 170. In the cylinder lock device 1 shown in FIG. 8, no protrusion portion 36 is formed in the rotor 30, and thus in a state in which the engagement of the clutch member 80 with the rotor 30 is released as shown in FIG. 11, the clutch member 80 is received by the slide drivers 70 and 170.

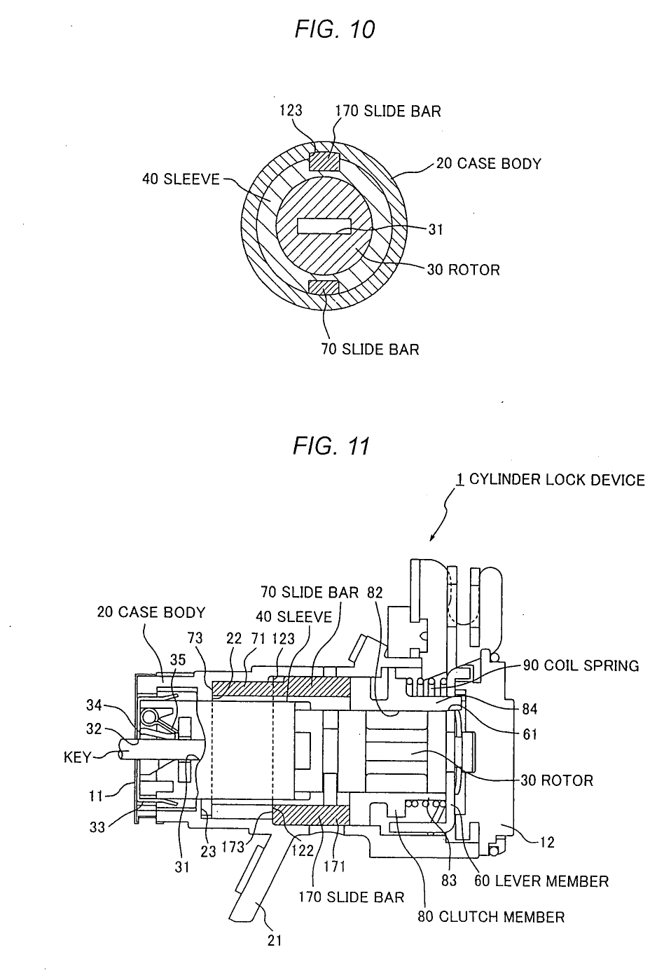

Although the two slide bars 70 and 170 are provided in this cylinder lock device 1 as well, these slide bars 70 and 170 are different in shape from each other. More specifically, as shown in FIG. 8, the axial extension portions 71 and 171 of the slide bars 70 and 170 are different in length from each other, and two kinds of recess portions 23 and 123 are formed in the case body 20. An inner surface of the case body 20 is formed in three steps so that its inside diameter changes in the individual steps. Thus, a slidable contact surface 22 with which the end face 73 of one slide bar 70 is slidably in contact, and a slidable contact surface 122 with which an end face 173 of the other slide bar 170 is slidably in contact are formed separately from each other. Also, as shown in FIGS. 9 and 10, the recess portions 23 and 123 are formed in the separate slidable contact surfaces 22 and 122, respectively.

With this construction as well, the rotor 30 and the clutch member 80 are engaged with each other only at one relative angle, which results in that the rotor 30 and the clutch member 80 are engaged with each other whenever the rotor 30 relatively rotates by 360° with respect to the clutch member 80. Thus, the inserted key cannot be de-inserted from the key insertion hole 31 of the rotor 30 unless the rotor 30 relatively rotates by 360° with respect to the clutch member 80. That is to say, in a state in which the rotor 30 rotates from the initial state, as shown in FIG. 11, the clutch member 80 moves to the lever member 60 side, so that the rotor 30 and the clutch member 80 are slidably in contact with each other. FIG. 11 shows a state in which the rotor 30 rotated by 180° from the initial state by using an improper key. That is to say, unlike the conventional cylinder lock device with which the key can be de-inserted from the key insertion hole every rotation of 180°, when a key two sides of which have different shapes is used, the key cannot be inserted into the key insertion hole with its both sides being reversed.

In addition, although the embodiment described above has shown the cylinder lock device 1 in which each of the slide bars 70 axially moves toward the lever member 60 side whenever the sleeve 40 relatively rotates by 360° with respect to the case body 20, for example, each of the slide bars 70 may axially move toward the lever member 60 side whenever the sleeve 40 relatively rotates by 180° with respect to the case body 20.

Moreover, although the cylinder lock device 1 has been shown which is provided with the slide bars 70 each serving as the slide member, for example, the slide member may have a cylindrical shape. Furthermore, it is to be understood that the rotor 30, the clutch member 80, and the like may be formed in arbitrary shapes, respectively, and in addition thereto, the concrete constructions or the like of the details of the constituent elements may also be suitably changed.

What is claimed is:

1. A cylinder lock device, comprising;
a cylindrical case body;
a rotor rotatably disposed inside said cylindrical case body, a key insertion hole being formed in said rotor so as to axially extend;
a sleeve rotatably disposed between said cylindrical case body and said rotor;
a plurality of tumblers provided in said rotor so as to be radially movable, said plurality of tumblers being radially urged outward to be engaged with said sleeve, the engagement of said plurality of tumblers with said sleeve being released when a normal key is inserted into said key insertion hole;
a rotatable lever member disposed on a side opposite to a key insertion side in said rotor so as to face said key insertion side;
a slide member disposed between said sleeve and said cylindrical case body, said slide member axially moving toward the lever member side whenever said sleeve relatively rotates with respect to said cylindrical case body by a predetermined angle;
a clutch member disposed between said rotor and said lever member, said clutch member being movably provided axially in said lever member; and
an urgement member for urging said clutch member to the rotor side so that said clutch member is engaged with said rotor;
wherein when said slide member moves toward said lever member side, the engagement of said clutch member with said rotor is released.

2. A cylinder lock device according to claim 1, further comprising a cam mechanism having a slidable contact surface formed in said case body, and a slidable contact portion formed in said slide portion, said slidable contact portion being adapted to be slidably in contact with said slidable contact surface, said cam mechanism serving to move axially said slide portion when said sleeve relatively rotates with respect to said case body.

3. A cylinder lock device according to claim 1, wherein in a state in which the engagement of said clutch member with said rotor is released, said clutch member urged by said urgement member is slidably in contact with said rotor.

4. A cylinder lock device according to claim 3, wherein a protrusion portion is formed in said rotor, and a recess portion which is engageable with said protrusion portion is formed in said clutch member, and in a state in which the engagement of said clutch member with said rotor is released, a portion other than said recess portion in said clutch portion is slidably in contact with said protrusion portion.

5. A cylinder lock device according to claim 4, wherein a protrusion portion which is engageable with said recess portion of said clutch member is formed in a peripheral surface on a side opposite to the key insertion side in said rotor.

6. A cylinder lock device according to claim 4, wherein the two protrusion portions are formed in said rotor at an interval of about 180°, and shapes of the recess portions of said clutch member are formed in correspondence to said two protrusion portions of said rotor.

7. A cylinder lock device according to claim 6, wherein said two protrusion portions of said rotor are formed in shapes different from each other, and said recess portions of said clutch member are also formed in shapes different from each other in correspondence to said two protrusion portions of said rotor having the different shapes.

8. A cylinder lock device according to claim 1, wherein in a state in which the engagement of said clutch member with said rotor is released, said clutch member urged by said urgement member is slidably in contact with said slide member.

9. A cylinder lock device according to claim 8, wherein said slide member is formed in nearly T-like shape, and has an axial extension portion which extends axially, and a circumferential extension portion which circumferentially extends at an end portion on the clutch member side of said axial extension portion and which is wider than said axial extension portion, and said circumferential extension portion is slidably in contact with said clutch member.

10. A cylinder lock device according to claim 1, wherein a reception groove which movably receives axially said slide member is formed in a side face of said sleeve.

11. A cylinder lock device according to claim 1, wherein the two slide members are provided and are disposed in two reception grooves which are formed on a peripheral surface of said sleeve, respectively, so as to be axially movable.

12. A cylinder lock device according to claim 1, wherein a cylinder portion which extends toward said lever member is formed in said clutch member, a plurality of coupling portions are protrusively formed in a head of said cylinder portion, and said plurality of coupling portions are inserted through insertion windows formed in said lever member, respectively.

13. A cylinder lock device according to claim 1, wherein said lever member is rotatably constructed, and said lever member rotates, thereby performing release or lock of said cylinder lock device used in a door of an automobile.

14. An engagement release mechanism for use in a cylinder lock device in which when a normal key is rotated in a state in which said normal key is inserted into a rotor disposed inside a cylindrical case body, a lever member rotates together with said rotor, thereby performing release or lock of said cylinder lock device, said engagement release mechanism serving to release engagement of said lever member with said rotor when an improper key is rotated in a state in which said improper key is inserted into said rotor, thereby idling said rotor with respect to said lever member, said engagement release mechanism comprising:
a clutch member for being engaged or de-engaged with or from said rotor or said lever member due to its axial movement;
a slidable contact surface formed in an inner surface of a cylindrical case body so as to circumferentially extend; and
a slide member for being slidably in contact with said slidable contact surface, said slide member axially moving along said slidable contact surface when an improper key is rotated in a state in which said improper key is inserted into said rotor to abut against said clutch member, thereby releasing said clutch member from said rotor or said lever member.

15. An engagement release mechanism according to claim 14, wherein in a state in which the engagement of said clutch member with said rotor is released, said clutch member is slidably in contact with said rotor.

16. An engagement release mechanism according to claim 15, wherein a protrusion portion is formed in said rotor, and a recess portion which is engageable with said protrusion portion is formed in said clutch member, and in a state in which the engagement of said clutch member with said rotor is released, a portion other than said recess portion in said clutch portion is slidably in contact with said protrusion portion.

17. An engagement release mechanism according to claim 16, wherein the two protrusion portions are formed in said rotor at an interval of about 180°, and shapes of said recess portions of said clutch member are formed in correspondence to said two protrusion portions of said rotor.

18. An engagement release mechanism according to claim 17, wherein said two protrusion portions of said rotor are formed in shapes different from each other, and said recess portions of said clutch member are also formed in shapes different from each other in correspondence to said two protrusion portions of said rotor having the different shapes.

19. An engagement release mechanism according to claim 14, wherein in a state in which the engagement of said clutch member with said rotor is released, said clutch member is slidably in contact with said slide member.

20. An engagement release mechanism according to claim 19, wherein said slide member is formed in nearly T-like shape, and has an axial extension portion which extends axially, and a circumferential extension portion which circumferentially extends at an end portion on the clutch member side of said axial extension portion and which is wider than said axial extension portion, and said circumferential extension portion is slidably in contact with said clutch member.
